(19) United States
(12) Patent Application Publication
(10) Pub. No.: US 2020/0001313 A1
(43) Pub. Date: Jan. 2, 2020

(54) PRESSURE WASHER WITH ELECTRONIC GOVERNOR

(71) Applicant: BRIGGS & STRATTON CORPORATION, Wauwatosa, WI (US)

(72) Inventors: Steve Bindl, Wauwatosa, WI (US); Joseph Giacalone, Hartland, WI (US); Brandon Gramoll, Wauwatosa, WI (US); Marvin Klowak, Germantown, WI (US); Robert Koenen, Wauwatosa, WI (US); Craig Serio, Wauwatosa, WI (US); Kyler Weid, Wauwatosa, WI (US); Bryan Zymanek, Menomonee Falls, WI (US)

(73) Assignee: BRIGGS & STRATTON CORPORATION, Wauwatosa, WI (US)

(21) Appl. No.: 16/456,466

(22) Filed: Jun. 28, 2019

Related U.S. Application Data
(60) Provisional application No. 62/692,368, filed on Jun. 29, 2018.

(51) Int. Cl. B05B 9/04; B08B 3/02

(52) U.S. Cl. CPC B05B 9/0426; B08B 2203/0241; B08B 3/026

(57) ABSTRACT

A pressure washer structured to output a pressurized fluid including an engine having a throttle plate structured to move between a closed position and a wide-open position, a pump driven by the engine and having an inlet and an outlet that discharges fluid, a spray gun having a spray gun inlet fluidly coupled to the outlet of the pump and a nozzle structured to discharge the fluid and having selectable nozzle orifices, and an electronic governor system structured to control a speed of the engine. The electronic governor system includes a carburetor, a motor coupled to the throttle plate to move the throttle plate between the closed and wide-open position, and a controller coupled to the motor to control the motor to control the speed of the engine in response to a selection of at least one of the one or more selectable nozzle orifices.

### CROSS-REFERENCE TO RELATED PATENT APPLICATIONS

This application claims the benefit of U.S. Provisional Application No. 62/692,368, filed Jun. 29, 2018, which is incorporated herein by reference in its entirety.

### BACKGROUND

Pressure washers, powered either by an internal combustion engine or an electric motor, are commonly used for cleaning applications that require high-pressure spray, such as car washing, concrete washing, etc.

### SUMMARY

One embodiment of the invention relates to a pressure washer structured to output a pressurized fluid. The pressure washer includes an engine having a throttle plate structured to move between a closed position and a wide-open position, a pump driven by the engine and having an inlet and an outlet that discharges fluid. The pressure washer further includes a spray gun having a spray gun inlet fluidly coupled to the outlet of the pump and a nozzle structured to discharge the fluid. The nozzle includes one or more selectable nozzle orifices. The pressure washer further includes an electronic governor system structured to control a speed of the engine. The electronic governor system includes a carburetor structured to mix incoming air with fuel for combustion in one or more cylinders of the engine, a motor coupled to the throttle plate and structured to move the throttle plate between the closed and wide-open position to control the flow of an air/fuel mixture from the carburetor, and a controller coupled to the motor to control the motor to control the speed of the engine in response to a selection of at least one of the one or more selectable nozzle orifices.

Another embodiment of the invention relates to a pressure washer structured to output a pressurized fluid. The pressure washer includes an engine having a throttle plate structured to move between a closed position and a wide-open position, a pump driven by the engine having an inlet and an outlet that discharges fluid and structured to pressurize the fluid, a spray gun having a spray gun inlet fluidly coupled to the outlet of the pump, and a nozzle structured to discharge the fluid. The nozzle includes one or more selectable nozzle orifices. The pressure washer includes an electronic governor system structured to control a speed of the engine. The electronic governor system includes a carburetor structured to mix incoming air with fuel for combustion in one or more cylinders of the engine, a motor coupled to the throttle plate and structured to move the throttle plate between the closed and wide-open position to control the flow of an air/fuel mixture from the carburetor, and a controller coupled to the motor to control the motor to control the throttle plate between the closed and wide-open position in response to a selection of at least one of the one or more selectable nozzle orifices.

Another embodiment of the invention relates to a pressure washer structured to output a pressurized fluid. The pressure washer includes an engine having a throttle plate structured to move between a closed position and a wide-open position and a pump having an inlet and an outlet that discharges fluid. The pump is driven by the engine and structured to pressurize the fluid. The pressure washer further includes a spray gun having a spray gun inlet fluidly coupled to the outlet of the pump and a nozzle structured to discharge the fluid. The nozzle includes one or more selectable nozzle orifices. The pressure washer also includes an electronic governor system structured to control the speed of the engine in response to a selection of at least one of the one or more selectable nozzle orifices.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a rear perspective view of a pressure washer, according to an exemplary embodiment.

FIG. 2 is a schematic diagram of the pressure washer of FIG. 1 with an electronic governor system.

FIG. 3 is a schematic diagram of a controller of the electronic governor system of FIG. 2.

FIG. 4 is a perspective view of a nozzle of the pressure washer of FIG. 1.

FIG. 5 is a front view of the nozzle of FIG. 4.

FIG. 6 is a rear view of the nozzle of FIG. 4.

FIG. 7 is a section view of the nozzle of FIG. 4 taken along section line 7-7.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the figures generally, a pressure washer with an electronic governor system is described. The electronic governor controls the speed of the engine and thus, the output of the water pump. When the pressure washer is in operation (e.g., the engine is started), but a no-spray condition is detected by the electronic governor system, the engine is controlled to an idle down condition (e.g., 2600-2800 revolutions per minute (RPM)). To accomplish an idle down condition, a controller of the electronic governor system controls a motor to move the throttle plate to a closed or idle position, thereby reducing the speed of the engine. The controller can control the motor to open the throttle plate to increase the engine speed. The controller is also structured to control the speed of the engine without regard to the position of the throttle plate (i.e., move the throttle plate to a position that results in a certain engine speed). Because an electronic governor system is used allowing for better engine speed control and regulation (over a manual linkage), lower idling speeds (e.g., 1500-2000 RPM) can be used and there is no need for the engine to be maintained in an idle condition at high speeds. Additionally, even if the pressure washer described herein is set in an active spray operating mode by the user, if the user is not actively using the pressure washer for a set period of time, the engine can be idled down. Using an electronic governor system also reduces speed variations under engine loading and unloading and reduces the potential for droop experienced while the engine is under load.

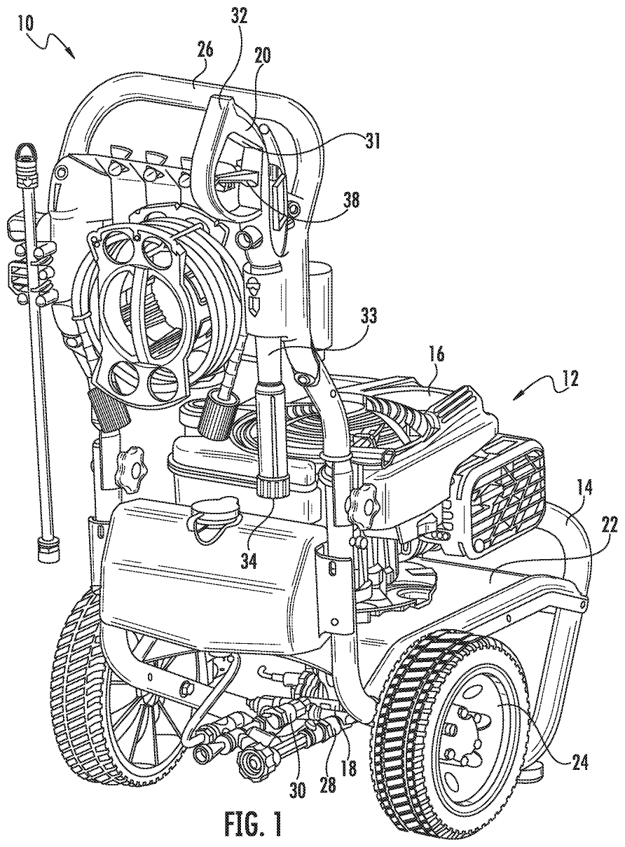

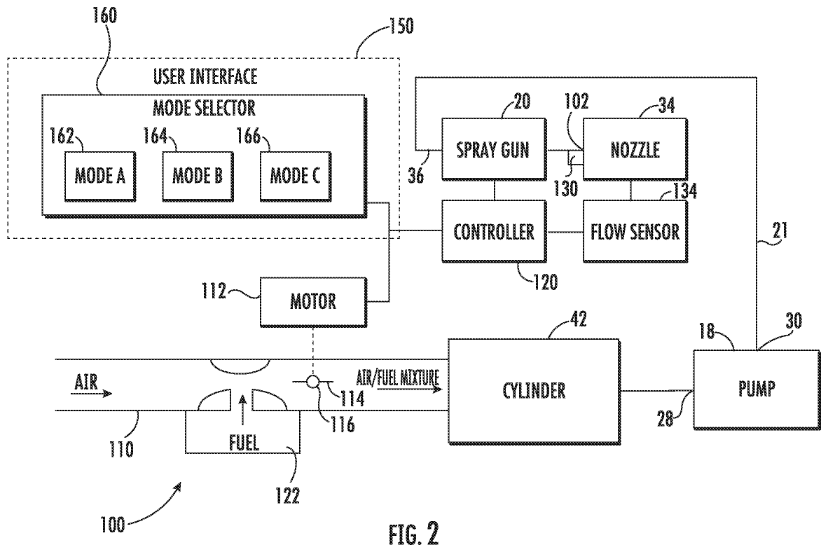

Referring to FIGS. 1-2, a pressure washer 10 includes a base unit 12 with a frame 14 supporting an internal combustion engine 16 and a water pump 18 (e.g., positive displacement pump, piston water pump, axial cam pump). The pressure washer 10 further includes a spray gun 20 that is coupled to the water pump 18 with a delivery conduit 21 (e.g., a high-pressure hose). In other embodiments, an electric motor is used as the prime mover. In some embodiments, the engine 16 is fastened to the top of a base plate 22 of the frame 14 and the water pump 18 is mounted below the base plate 22 and connected to a power takeoff of the engine 16 via a hole through the base plate 22. In other embodiments, the water pump 18 is directly coupled to and supported by the engine or prime mover. The water pump 18 is coupled (e.g., directly coupled, indirectly coupled by a transmission, belts, gears, or other drive system) to the engine 16 to be driven by the engine 16. For example, the water pump 18 is configured to be coupled to the power takeoff of the engine 16. Accordingly, the speed of the pump 18 can be a function of the speed of the engine 16.

The water pump 18 includes a pumping mechanism to pressurize water passing through the water pump 18 (e.g., water pressurized in a range between 50 pounds per square inch (psi) and 4200 psi). The water pump 18 includes a pump inlet 28 and a pump outlet 30. The pump inlet 28 is configured to be coupled to a supply conduit or hose, which is in turn connected to a fluid supply 40 (e.g., a spigot connected to a municipal water supply or well). In some embodiments, the pump inlet 28 includes a low-pressure, garden-hose style fitting for coupling a garden hose to the pump inlet 28. The pump outlet 30 includes a high-pressure fitting (e.g., an M22 fitting) for coupling the pump outlet 30 to the delivery conduit 21 or other device including an appropriate high pressure fitting. In some embodiments, the pressure washer 10 is portable and includes wheels 24 and a handle 26. In other embodiments, the pressure washer 10 may be stationary. In other embodiments, the pressure washer 10 is mounted to a trailer or other vehicle. As shown in FIG. 1, pressure washer 10 uses a vertical shaft engine. According to an alternative embodiment, the engine may be a horizontal shaft engine.

The spray gun 20 includes a handle 32 and a nozzle 34. High pressure water is provided to the spray gun 20 from the pump outlet 30 through the delivery conduit 21, which is coupled to the spray gun 20 via an inlet 36. The inlet 36 may be a threaded fitting, such as a high-pressure fitting (e.g., an M22 fitting). The stream of water output from the nozzle 34 can be started or stopped by a user applying pressure to a trigger 38 (FIG. 1). The spray gun 20 allows the user to manage the direction of the stream of water independent of the location and orientation of the base unit 12 and the duration of the stream of water. The spray gun 20 may be configured to be grasped with two hands, with one hand being placed on the handle 32 and a second hand being placed on a grip portion 31 provided by a body 33 (e.g., barrel, housing, etc.). The grasping of the spray gun 20 with two hands allows a user to have greater control of the stream of water expelled from the nozzle 34.

Referring to FIG. 2, the pressure washer 10 further includes an electronic governor system 100, according to an exemplary embodiment. The electronic governor system 100 includes a carburetor 110, a motor 112, a throttle plate 114, and a throttle lever 116. In the carburetor 110, fuel from the fuel tank 122 is mixed with incoming air to produce an air/fuel mixture for combustion in one or more cylinders 42 of the engine 16. The throttle plate 114 controls the flow of the air/fuel mixture out of the carburetor 110 and in doing so controls the speed of the engine 16.

The motor 112 is used to control the position of the throttle plate 114, thereby controlling the speed of the engine 16. The throttle plate 114 is movable between a closed position (e.g., idle position) and a wide-open position. The position of the throttle plate 114 is adjusted so that the engine speed is maintained at a desired engine speed. The desired engine speed can be a constant or can be varied by a user or a controller 120 in response to inputs from the engine 16 (e.g., inputs related to engine load, pressure washer mode selection, desired output, or other engine operating conditions or objectives). In some embodiments, the pressure washer 10 includes a higher displacement pump 18 to allow for a higher flow rate from the spray gun 20. In this case, the controller 120 slows the speed of the engine 16 by controlling the motor 112 to close the throttle plate 114 during high-pressure inputs (e.g., a high-pressure mode or nozzle is selected).

The electronic governor system 100 includes a controller 120 coupled to the motor 112 and configured to control the operation of the motor 112. The controller 120 receives inputs from one or more of a nozzle sensor 130, a flow sensor 134, and a mode selector 160. Based on the inputs from one or more sensors or user interfaces, the controller 120 controls the speed of the engine 16. To do so, the controller 120 controls the motor 112 to move the throttle plate 114 between the wide-open position and the closed position (e.g., idle position) to thereby control the speed of the engine 16 and the output of the pump 18. Accordingly, the controller 120 is communicably and operatively coupled to the nozzle sensor 130, the flow sensor 134, and the mode selector 160. The controller 120 receives inputs relating to the operation of the pressure washer 10 and any user nozzle or mode selections and controls the engine speed to control the output of the pump 18. For example, the controller 120 can detect that a high-pressure, low-flow nozzle type is being used and can in turn, control the motor 112 to open the throttle plate 114 to increase engine speed and the output of the pump 18. In addition, the controller 120 can detect that the spray gun 20 is not being operated (e.g., trigger 38 is not activated, flow sensor 134 is not detecting any fluid flow), and can idle down the pressure washer by operating the motor 112 to move the throttle plate 114 to an idle position (e.g., closed position). In this way, the engine 16 can automatically idle down at a much lower speed when little or no load is applied to the engine 16. The idle down feature can increase the life of the engine 16 and pump 18, reduce the noise emitted from the engine 16, and reduce the fuel consumption of the engine 16 over time.

The pressure washer 10 may be changed from an active spraying condition to an idle or no-spray condition. The controller 120 detects the spray condition and operates the motor 112 to move the throttle plate 114 accordingly. For example, the controller 120 (by communicating with one or more sensors) detects a no-spray condition and controls the motor 112 to move the throttle plate 114 to an idle position. In one embodiment, when a user releases the trigger 38 on the spray gun 20, a sensor on the gun detects that the trigger 38 is released. When the sensor detects the trigger 38 has been released, the sensor communicates the information to the controller 120. The release of the trigger 38 may therefore be utilized to change the speed of the engine 16, such as to an idle speed. In another embodiment, the sensor may be a pressure sensor that is configured to sense the presence of a user's hand on the grip portion 31 of the spray gun 20. In some embodiments, the grip portion 31 and/or the trigger 38 can include a variable grip sensor, where the speed of the engine 16 (and thus, the pressure of the output fluid flow) is changed based on the force with which the user grips the grip portion 31. For example, the harder the user squeezes the grip portion 31 or trigger 38, the resulting speed of the engine 16 is higher, and the softer the user squeezes the grip portion 31 or trigger 38, the resulting speed of the engine 16 is lower.

The nozzle sensor 130 is configured to sense the type of nozzle 34 used with the spray gun 20 and/or the selected orifice (e.g., first orifice on a rotatable nozzle. Each type of nozzle 34 or selected orifice on the nozzle 34 produces a different flow characteristic for the fluid flowing through the spray gun 20. As described further below, depending on the selected nozzle 34 or selected orifice, a different type of flow is produced. The different orifice sizes have a different load effect on the engine 16. Accordingly, when changing between nozzle orifices, the nozzle sensor 130 may detect the nozzle type or orifice size selected, which is communicated to the controller 120 to, in some embodiments, preemptively change the throttle plate 114 position to account for the different load on the engine 16.

The flow sensor 134 is configured to sense flow characteristics including pressure and flow rate of the fluid flowing through the spray gun 20. As shown in FIG. 2, the flow sensor 134 is coupled to the spray gun 20 and nozzle 34 to sense flow rate data and pressure data of the fluid and coupled to the controller 120. Accordingly, the pressure and flow rate data from the flow sensor 134 is communicated to the controller 120 to control the motor 112 operation and throttle plate 114 position.

Referring still to FIG. 2, changes in the characteristics of the spray from the spray gun 20 may occur when the water pump 18 output is changed based on a selected mode and/or when the nozzle orifice is changed. The pressure washer 10 includes a user interface 150 to allow a user to select between operating modes. The user interface 150 can be positioned on the pressure washer 10. In other embodiments, the user interface 150 can be positioned on the spray gun 20. Wireless communication established between the user interface 150 and the electronic governor system 100 (e.g., controller 120) can allow for positioning of the user interface 150 remotely on the spray gun 20 or some other remote position (e.g., mobile device of the user via Bluetooth, ZigBee, Near-Field Communication (NFC), LoRa, etc.). The user interface 150 includes a mode selector 160 having various modes (e.g., mode A 162, mode B 164, mode C 166). As an example, mode A 162 includes a car washing mode, mode B 164 includes a siding mode, and mode C 166 includes a concrete mode. By selecting each mode, the user can select between varying flow characteristics provided by the pressure washer 10. For example, by selecting mode A 162 (e.g., “car mode”), the user selects a low-pressure, high-flow mode (e.g., 500 psi). By selecting mode B 164 (e.g., “siding mode”), the user selects a medium-pressure, medium-flow mode (e.g., 1800-2300 psi). By selecting mode C 166 (e.g., “concrete mode”), the user selects a high-pressure, low-flow mode (e.g., 2500-4200 psi).

The mode selector 160 can include more or fewer modes from which a user can select an operating condition of the pressure washer 10. Another mode can include a quiet mode, where the engine 16 is started at an idle condition and idled down during a no-spray condition of the pressure washer 10. Another selectable mode can include a power boost mode, where the throttle open condition is reserved to allow for a boost setting of the pressure washer. In the power boost mode, the normal high-pressure operation of the pressure washer can be at 85% capacity and the power boost mode can be implemented for a temporary amount of time. In some embodiments, a fuel-saving eco-mode is included, where the engine speed is modified based on a desired flow rate.

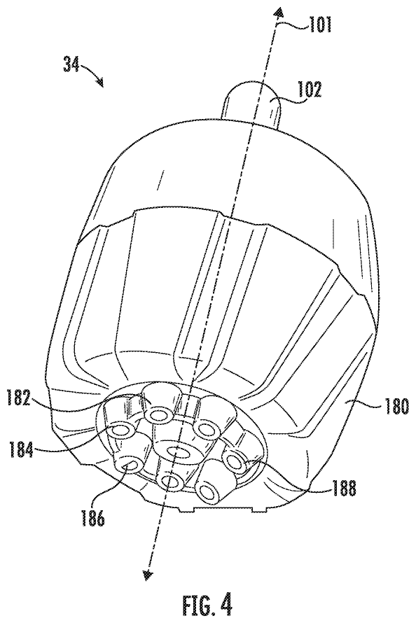

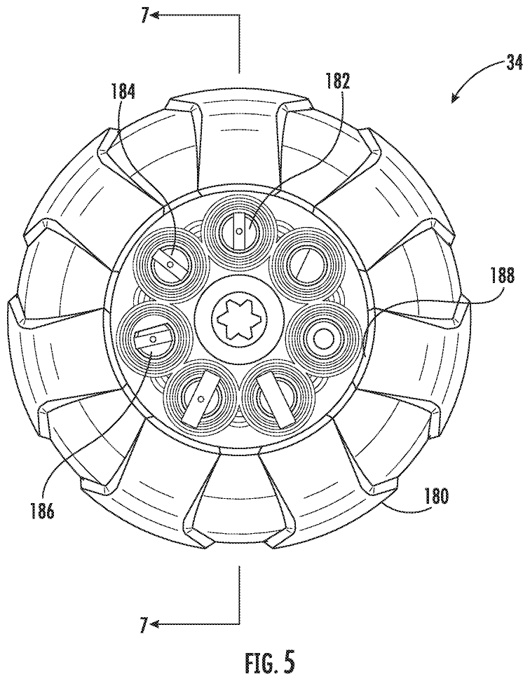

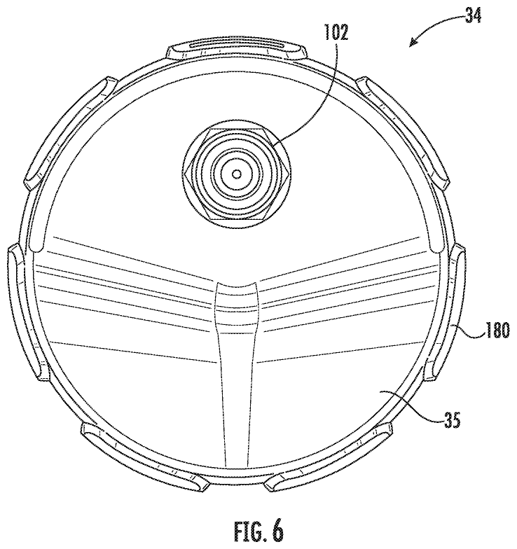

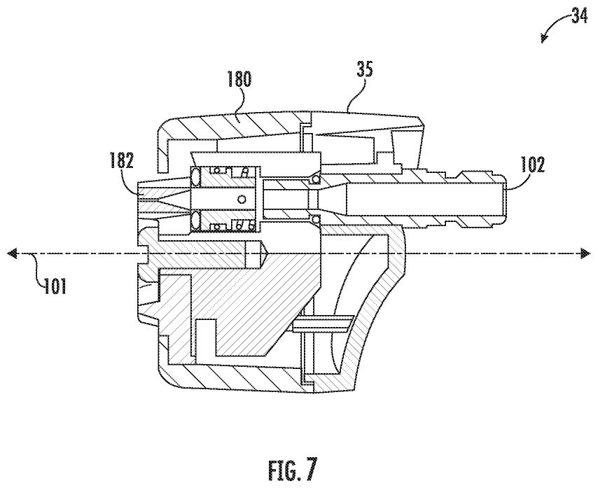

Referring now to FIGS. 4-7 the nozzle 34 is shown in more detail, according to an exemplary embodiment. The nozzle 34 includes a housing 35 having an inlet 102 fluidly coupled to the pump outlet 30 via the delivery conduit 21 (FIG. 2). The nozzle 34 includes multiple, selectable orifices (e.g., first orifice 182, second orifice 184, third orifice 186, fourth orifice 188, etc.) through which water can be dispensed at varying pressures and flow rates. The nozzle 34 includes a rotatable selector 180 configured to allow a user to rotate between the multiple orifices to achieve varying flow characteristics. The rotatable selector 180 is rotatable relative to the housing 35 about the longitudinal axis 101 of the nozzle 34. The orifices are positioned around the longitudinal axis 101 of the nozzle 34. The rotatable selector 180 can be rotated clockwise or counterclockwise to select between orifices. Any number of orifices can be included. The orifices can be positioned in any sequence or order on the nozzle and can be selected in any order by the user.

The first orifice 182 has a first effective flow area (e.g., diameter or cross-sectional area) suitable for generating a high-pressure, low-flow fluid stream (e.g., approximately 2500-4000 psi at 2.5 gallons per minute (gpm)). The first orifice 182 is configured to generate a small, pinpoint type stream (e.g., 0 degree spray, ranging from 0 to 10 degree spray). The high-pressure, low-flow fluid stream generated by the first orifice 182 may atomize immediately or soon after the fluid stream exits the first orifice 182. The high-pressure, low-flow stream is suitable for pressure washing applications like removing debris, dirt, grime, mold, etc. from concrete surfaces, such as a drive way or sidewalk. The second orifice 184 has a second effective flow area (e.g., diameter or cross-sectional area) that is greater than the first flow area and is suitable for generating a relatively high-pressure, low-flow fluid stream (e.g., approximately 1800-2300 psi). The second orifice 184 is configured to generate a relatively larger fluid stream (e.g., larger in diameter or cross-sectional area) than the first orifice 182 (e.g., 15 degree spray, ranging from 10 to 20 degree spray). The high-pressure, low-flow stream generated by the second orifice 184 is suitable for pressure washing applications like removing debris, dirt, grime, mold, etc. from a deck, patio, fence, siding, or other surface or structure.

The third orifice 186 has a third effective flow area (e.g., diameter or cross-sectional area) that is greater than the first and second flow areas and is suitable for generating a relatively lower-pressure, higher-flow fluid stream (e.g., 500 psi at 5.0 gpm). The third orifice 186 is configured to generate a relatively larger fluid stream (e.g., larger in diameter or cross-sectional area) than the first and second orifices 182, 184 (e.g., 40 degree spray, ranging from 30 to 50 degree spray) and in a flat, fan-shaped spray. The low-pressure, high-flow fluid stream generated by the second orifice 188 substantially maintains its shape for a sizable distance from the second orifice 188. The low-pressure high-flow fluid stream is a coherent or concentrated stream that can be sent sizable distances from the spray gun 20. The low-pressure, high-flow fluid stream is suitable for washing a car and flushing or low-pressure cleaning at a distance.

The fourth orifice 188 has a fourth effective flow area (e.g., diameter or cross-sectional area) that is greater than the first, second, and third flow areas and is suitable for generating a very low-pressure, high-flow fluid stream (e.g., 100 psi). The fourth orifice 188 is configured to generate a larger fluid stream (e.g., larger in diameter or cross-sectional area) than the first, second, and third orifices 182, 184, 186. The low-pressure, high-flow fluid stream generated by the fourth orifice 188 is suitable for low pressure washing applications. In other embodiments, one or more of the orifices may be configured to dispense the water in different spray shapes (e.g., a narrow, confined stream, a conical stream, a pulsing stream, etc.), flow rates, and pressures.

As described below, in response to the mode selection on the user interface 150 and the orifice selection on the nozzle 34, the controller 120 operates the motor 112 to adjust the throttle plate 114 and thus, adjust the speed of the engine 16 and the output of the pump 18. Different nozzle orifices used with different modes of operation (e.g., mode A 162, mode B 164, mode C 166) may be ideal for different cleaning tasks. Operation of the pressure washer 10 in mode C 166 with the first orifice 182 may be ideal for cleaning concrete surfaces, while operation with the second orifice 184 may be ideal for cleaning home siding surfaces. To wash a car, mode B 162 may be used in combination with the third or fourth orifice 186, 188, for example, and so on. Accordingly, the pressure washer 10 may be used for a broad range of outdoor applications that would otherwise require multiple water spraying devices.

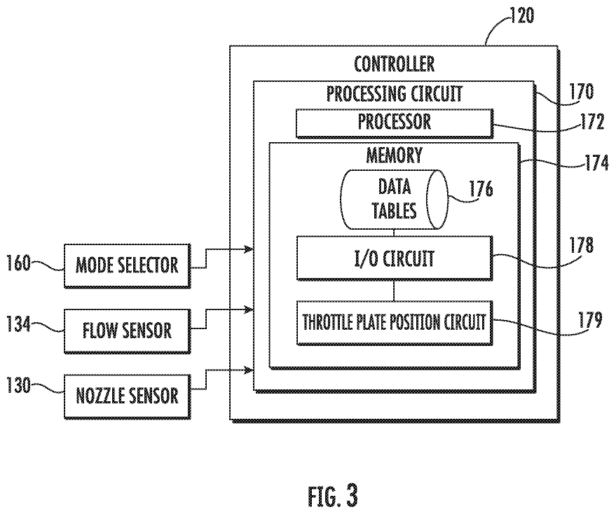

Referring now to FIG. 3, the controller 120 includes a processing circuit 170. The processing circuit 170 includes a processor 172. The processing circuit 170 and processor 172 are configured to receive inputs from various sensors and components (e.g., via a wired or wireless communication link with other components of the engine and/or automatic choking system) and to provide an output (e.g., via a wired or wireless communication link to the motor 112, other components of the engine, and/or other components of the electronic governor system). The processing circuit 170 can be a circuit containing one or more processing components (e.g., the processor 172) or a group of distributed processing components. The processor 172 may be a general purpose or specific purpose processor configured to execute computer code or instructions stored in the memory or received from other computer readable media (e.g., CD-ROM, network storage, a remote server, etc.). In some embodiments, the processing circuit 170 includes a memory 174. The memory 174 may be RAM, hard drive storage, temporary storage, non-volatile memory, flash memory, optical memory, or any other suitable memory for storing software objects and/or computer instructions. When the processor 172 executes instructions stored in the memory 174 for completing the various activities described herein, the processor 172 generally configures the computer system and more particularly the processing circuit 170 to complete such activities. The memory 174 may include database components, object code components, script components, and/or any other type of information structure for supporting the various activities described in the present disclosure. For example, the memory 174 may store data regarding the operation of a controller. According to an exemplary embodiment, the memory 174 is communicably connected to the processor 172 and includes computer code for executing one or more processes described herein and the processor 172 is configured to execute the computer code.

The controller 120 includes a tables database 176 configured to hold, store, categorize, and otherwise serve as a repository for various information relating to the electronic governor system 100 and engine 16. The tables database 176 provides access to one or more expected (e.g., normal, predetermined) operational parameters for the engine 16 and electronic governor system 100. For example, the tables database 176 stores various throttle plate positions, flow values, pressure values, engine speed data, time data, etc. The tables database 176 may include different data tables for different models of engines, different types of equipment, ambient temperatures, etc.

The controller 120 further includes an input/output (I/O) circuit 178. The I/O circuit 178 is communicably and operatively coupled to various components of the electronic governor system 100. The I/O circuit 178 thus includes input and output electrical connections allowing the controller 120 to receive sensed values and transmit control signals or instructions to various components of the electronic governor system 100. For example, the I/O circuit 178 is electrically coupled to the nozzle sensor 130 to receive data indicative of a type or size of nozzle used with the spray gun 20 and is electrically coupled to the motor 112 to transmit control signals to open and close the throttle plate 114 based on instructions received from the circuits included with the controller 120 as described further herein. As another example, the I/O circuit 178 is electrically coupled to the flow sensor 134 to receive data indicative of the flow rate and pressure of the fluid flowing through the spray gun 20 and is electrically coupled to the motor 112 to transmit control signals to open and close the throttle plate 114 based on a desired engine speed relative to the required output of the pump 18. As another example, the I/O circuit 178 is electrically coupled to the mode selector 160 to receive data indicative of the mode the user has selected (e.g., car mode, concrete mode, siding mode, etc.) and is electrically coupled to the motor 112 to transmit control signals to open and close the throttle plate 114 based on the selected mode and relative required engine speed and pump output to meet that mode.

The controller 120 also includes a throttle plate position circuit 179. The throttle plate position circuit 179 is configured to determine the desired position of the throttle plate 114 based on sensed characteristics of the fluid flowing through the spray gun 20 and/or sensed mode selections made from the user interface 150. The controller 120 receives sensed flow rate and pressure values through the I/O circuit 178 and communicates the data to the throttle plate position circuit 179 to determine the desired throttle plate 114 position. The throttle plate position circuit 179 is also configured to track the expected changes in the throttle plate 114 position from an initial throttle plate 114 position. The initial throttle plate position may be known. For example, the wide open position may be considered to be 90° and the closed position may be considered to be 0°. Based on that starting position (e.g., wide-open position), the throttle plate position circuit 179 calculates a current throttle plate 114 position based on the changes to the throttle plate 114 position caused by the motor 112. By keeping track of all expected movements of the throttle plate 114 from the initial known position caused by operation of the motor 112, the throttle plate position circuit 179 is able to track the position of the throttle plate 114.

In operation, the user starts the engine 16 to begin operation of the pump 18. The pump 18 draws low-pressure fluid from the source, increases the pressure of the fluid, and delivers the fluid to the spray gun 20. The user grasps the spray gun 20 (e.g., at handle 32 and trigger 38) and aims it at the surface to be cleaned, selects an orifice size by rotating the rotatable selector 180 on the nozzle 34, then pulls the trigger 38 to open the valve and initiate the flow of fluid out of the spray gun 20. The engine 16 operates at a desired speed during the discharge of water from the spray gun 20 to produce a flow of fluid that discharges from one of the orifices (e.g., first orifice 182, second orifice 184, third orifice 186, fourth orifice 188) of the nozzle 34. Based on the operating mode, the orifice selected, and whether the trigger 38 of the spray gun 20 is activated, the load on the engine can vary greatly. Accordingly, in response to one or more of these conditions, the controller 120 controls the motor 120 to change the throttle plate 114 position and change the engine speed.

In some embodiments the water pump 18 described herein further includes an unloader valve to divert pressurized water to a recirculation circuit of the pump 18 during times when the engine 16 is driving the pump 18, but the outlet 30 of the pump 18 is blocked, such as when the spray gun 20 is not actively spraying. In some embodiments, the unloader valve is a trapped-pressure unloader and is activated by the presence or absence of trapped pressure in the delivery conduit 21 between the pump 18 and the spray gun 20. When the pump 18 is activated but the spray gun 20 is not spraying fluid, back pressure in the conduit 21 exceeds the water pressure internal to the pump 18 such that the unloader valve opens a bypass conduit.

In some embodiments, the engine 16 can be pulsated to pulse the water flowing through the spray gun 20. In some embodiments, to achieve a pulsing fluid flow, the pressure washer can include an actuator to pulsate the water, where the actuator can be controlled by the controller 120. In some embodiments, the pulsating flow can be activated by a user at the spray gun 20. In some embodiments, actuation of the trigger 38 starts the engine 16. In this case, upon actuation of the trigger 38 by a user, a valve is operated to start and stop flow of water from the spray gun 20, where a wireless transmitter is configured to transmit a start signal to the engine 16 to start operation upon actuation of the trigger 38.

In some embodiments, the electronic governor system 100 is used in combination with automatic choke system to improve on starting the engine 16 in cold temperatures. The automatic choke system controls a choke plate position based on ambient temperature values such that if a sensed temperature value indicates a temperature below a cold operating threshold (e.g., 40 degrees Fahrenheit), the choke system moves the choke plate to a cold start or full choke position. If the sensed temperature value indicates a temperature at or above a hot operating condition, the choke system moves the choke plate to a hot restart or full relief position.

As utilized herein, the terms “approximately,” “about,” “proximate,” “substantially,” and similar terms are intended to have a broad meaning in harmony with the common and accepted usage by those of ordinary skill in the art to which the subject matter of this disclosure pertains. These terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “exemplary” as used herein to describe various embodiments is intended to indicate that such embodiments are possible examples, representations, and/or illustrations of possible embodiments.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the accompanying drawings. The orientation of various elements may differ according to other exemplary embodiments, and that such variations are intended to be encompassed by the present disclosure.

The construction and arrangement of the pressure washer as shown in the various exemplary embodiments is illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pressure washer structured to output a pressurized fluid comprising:
an engine having a throttle plate structured to move between a closed position and a wide-open position;
a pump having an inlet and an outlet that discharges fluid, wherein the pump is driven by the engine and structured to pressurize the fluid;
a spray gun having a spray gun inlet fluidly coupled to the outlet of the pump, and a nozzle structured to discharge the fluid, wherein the nozzle includes one or more selectable nozzle orifices; and
an electronic governor system structured to control a speed of the engine, the electronic governor system comprising:
a carburetor structured to mix incoming air with fuel for combustion in one or more cylinders of the engine;
a motor coupled to the throttle plate and structured to move the throttle plate between the closed and wide-open position to control the flow of an air/fuel mixture from the carburetor; and
a controller coupled to the motor to control the motor to control the speed of the engine in response to a selection of at least one of the one or more selectable nozzle orifices.

2. The pressure washer of claim 1, further comprising:
a user interface comprising a mode selector having one or more selectable mode options;
wherein the controller controls the motor to open and close the throttle plate in response to a selection of at least one of the one or more selectable mode options.

3. The pressure washer of claim 2, wherein the user interface is positioned on the spray gun, the user interface communicably coupled to the electronic governor system via wireless communication.

4. The pressure washer of claim 2, where the controller controls the motor to move the throttle plate to the wide-open position when a high-pressure and low-flow mode is selected.

5. The pressure washer of claim 2, wherein the controller controls the motor to move the throttle plate to an intermediary position between the closed position and the wide-open position when a low-pressure and high-flow mode is selected.

6. The pressure washer of claim 1, further comprising a flow sensor fluidly coupled to the spray gun and communicably coupled to the controller, the flow sensor structured to detect at least one of a pressure value and a flow-rate value of the fluid flowing through the spray gun;
wherein the controller controls the motor to move the throttle plate to the closed position upon receiving a no-flow data value from the flow sensor indicative of no fluid flowing through the spray gun.

7. The pressure washer of claim 1, further comprising:
a nozzle sensor coupled to the nozzle and communicably coupled to the controller, the nozzle sensor structured to detect the one or more selectable nozzle orifices;
a flow sensor fluidly coupled to the spray gun and communicably coupled to the controller, the flow sensor structured to detect at least one of a pressure value and a flow-rate value of the fluid flowing through the spray gun; and
a user interface comprising a mode selector having one or more selectable mode options;
wherein the controller controls the motor to move the throttle plate between the wide-open position and the closed position based on the detection of the one or more selectable nozzle orifices, based on the detection of flow values received from the flow sensor, and based on a selection of at least one of the one or more selectable mode options.

8. The pressure washer of claim 7, wherein the controller controls the motor to move the throttle plate to the closed position upon receiving a no-flow data value from the flow sensor indicative of no fluid flowing through the spray gun.

9. The pressure washer of claim 7, wherein the controller controls the motor to move the throttle plate to the wide-open position upon receiving active-flow data value from the flow sensor indicative of fluid flowing through the spray gun, receiving an indication of selection of a high-pressure nozzle orifice, and receiving data indicative of selection of a high-pressure mode.

10. The pressure washer of claim 7, wherein the controller controls the motor to move the throttle plate to an intermediary position between the wide-open position and the closed position upon receiving active-flow data value from the flow sensor indicative of fluid flowing through the spray gun, receiving an indication of selection of a low-pressure nozzle orifice, and receiving data indicative of selection of a high-pressure mode.

11. A pressure washer structured to output a pressurized fluid comprising:
an engine having a throttle plate structured to move between a closed position and a wide-open position;
a pump having an inlet and an outlet that discharges fluid, wherein the pump is driven by the engine and structured to pressurize the fluid;
a spray gun having a spray gun inlet fluidly coupled to the outlet of the pump, and a nozzle structured to discharge the fluid, wherein the nozzle includes one or more selectable nozzle orifices; and
an electronic governor system structured to control a speed of the engine, the electronic governor system comprising:
a carburetor structured to mix incoming air with fuel for combustion in one or more cylinders of the engine;
a motor coupled to the throttle plate and structured to move the throttle plate between the closed and wide-open position to control the flow of an air/fuel mixture from the carburetor; and
a controller coupled to the motor to control the motor to control the throttle plate between the closed and wide-open position in response to a selection of at least one of the one or more selectable nozzle orifices.

12. The pressure washer of claim 11, further comprising a nozzle sensor coupled to the nozzle and communicably coupled to the controller, the nozzle sensor structured to detect the one or more selectable nozzle orifices;
wherein the controller controls the motor to move the throttle plate between the wide-open position and the closed position based on the detection of the one or more selectable nozzle orifices.

13. The pressure washer of claim 12, wherein the controller controls the motor to move the throttle plate to the wide-open position upon receiving an indication of a first orifice selection, wherein the first orifice is a high-pressure nozzle producing a first spray of high-pressure and low-flow fluid.

14. The pressure washer of claim 13, wherein the controller controls the motor to move the throttle plate to a second position between the wide-open position and the closed position upon receiving an indication of a second orifice selection, wherein the second orifice produces a second spray ranging from a ten to a twenty degree spray.

15. The pressure washer of claim 14, wherein the controller controls the motor to move the throttle plate to a third position between the wide-open position and the closed position upon receiving an indication of a third orifice selection, wherein the third orifice produces a third spray ranging from a thirty to a fifty degree spray;
wherein the third position is nearer the closed position than the second position.

16. The pressure washer of claim 15, wherein the controller controls the motor to move the throttle plate to a fourth position between the wide-open position and the closed position upon receiving an indication of a fourth orifice selection, wherein the fourth orifice is a high-flow nozzle producing a fourth spray of high-flow and low-pressure fluid;
wherein the fourth position is nearer the closed position than the third position.

17. The pressure washer of claim 16, wherein the one or more selectable nozzle orifices are radially positioned about an axis of rotation of the nozzle.

18. The pressure washer of claim 16, wherein the spray gun includes a grip and a trigger structured to control the flow of fluid from the spray gun, wherein a grip sensor is positioned on a grip portion of at least one of the grip and the trigger;
wherein the grip sensor communicates grip pressure values to the controller and the controller controls the motor to move the throttle plate between the wide-open position and the closed position in response to the grip pressure values.

19. A pressure washer structured to output a pressurized fluid comprising:
an engine having a throttle plate structured to move between a closed position and a wide-open position;
a pump having an inlet and an outlet that discharges fluid, wherein the pump is driven by the engine and structured to pressurize the fluid;
a spray gun having a spray gun inlet fluidly coupled to the outlet of the pump, and a nozzle structured to discharge the fluid, wherein the nozzle includes one or more selectable nozzle orifices; and
an electronic governor system structured to control the speed of the engine in response to a selection of at least one of the one or more selectable nozzle orifices.

20. The pressure washer of claim 19, further comprising:
a user interface comprising a mode selector having one or more selectable mode options;
wherein the electronic governor system controls the speed of the engine in response to a selection of at least one of the one or more selectable mode options.
